(19) United States
(12) Patent Application Publication
(10) Pub. No.: US 2023/0176364 A1
(43) Pub. Date: Jun. 8, 2023

(54) SCANNING OPTICAL DEVICE

(71) Applicant: BROTHER KOGYO KABUSHIKI KAISHA, Nagoya (JP)

(72) Inventors: Junichi Yokoi, Nagoya (JP); Yohei Takahashi, Nagoya (JP); Hiroyuki Ominato, Nagoya (JP)

(73) Assignee: BROTHER KOGYO KABUSHIKI KAISHA, Nagoya (JP)

(21) Appl. No.: 18/060,693

(22) Filed: Dec. 1, 2022

(30) Foreign Application Priority Data
Dec. 6, 2021 (JP) 2021-197612
Dec. 6, 2021 (JP) 2021-197613
Dec. 6, 2021 (JP) 2021-197614

(51) Int. Cl. G02B 26/12

(52) U.S. Cl. CPC G02B 26/124; G02B 26/129

(57) ABSTRACT

A scanning optical device includes a light source, a polygon mirror, a motor, a scanning optical system, a frame, and a seating surface. The scanning optical system comprises a first scan lens, a second scan lens, and a reflecting mirror. The reflecting mirror is arranged to reflect a light beam toward the second scan lens. The reflecting mirror is supported on the seating surface. The seating surface allows adjustment of an angle of the reflecting mirror. The reflecting mirror reflects the light beam in a direction from the base wall toward the open side. A part of the reflecting mirror that overlaps the seating surface as viewed in a direction of thickness of the reflecting mirror is exposed to an outside of the frame and accessible from a side of the frame opposite to an open side of the frame.

### REFERENCE TO RELATED APPLICATIONS

This application claims priority from Japanese Patent Application Nos. 2021-197614, 2021-197612, and 2021-197613 filed on Dec. 6, 2021. The entire contents of the priority applications are incorporated herein by reference.

### BACKGROUND ART

A scanning optical device known in the art comprises a light source, a polygon mirror that deflects a light beam emitted from the light source, a motor that rotates the polygon mirror, and a housing that includes a base wall and a side wall. The motor is fixed to the base wall and a light beam is let out from an open side of the housing opposite to the side on which the base wall is formed. When the scanning optical device is assembled, each reflecting mirror is manipulated from the open side of the housing, i.e., from the side through which the light beam is let out from the scanning optical device to adjust the angle of the reflecting mirror.

The scanning optical device further comprises four scanning optical systems each comprising a first scan lens, a second scan lens, and a reflecting mirror. The four second scan lenses of the four scanning optical systems are aligned, with the polygon mirror in the center. Two of the second scan lenses are located on one side of the polygon mirror, and the other two of the second scan lenses are located on the other side of the polygon mirror. Each of the second scan lenses is disposed such that a center of each lens is offset with respect to a light beam let out from the scanning optical device so that an optical characteristic of each lens is not degraded.

### DESCRIPTION

According to such scanning optical device, since operation for adjustment of the angle of the reflecting mirror is performed from the open side of the housing during assembly of the scanning optical device, it is difficult to adjust the angle of the reflecting mirror.

It would be desirable to provide a scanning optical device having features which would facilitate adjustment of the angle of the reflecting mirror during assembly of the scanning optical device.

Thus, in one aspect, a scanning optical device disclosed herein comprises a light source, a polygon mirror, a motor, a scanning optical system, a frame, and a seating surface. The light source emits a light beam. The polygon mirror deflects the light beam emitted from the light source. The motor rotates the polygon mirror about a rotation axis parallel to a first direction. The scanning optical system comprises a first scan lens, a second scan lens, and a reflecting mirror. The first scan lens receives the light beam deflected by the polygon mirror. The second scan lens directs the light beam toward an image plane. The reflecting mirror is arranged to reflect the light beam toward the second scan lens. The scanning optical system is fixed to the frame. The frame comprises a base wall and a side wall. The motor is fixed to the base wall. The side wall protrudes from the base wall in the first direction along an outer edge of the base wall to form an open side of the frame that opens in the first direction. The reflecting mirror is supported on the seating surface in a manner that allows adjustment of an angle of the reflecting mirror. The reflecting mirror reflects the light beam toward the open side. A part of the reflecting mirror that overlaps the seating surface as viewed in a direction of thickness of the reflecting mirror is exposed to an outside of the frame and accessible from a side of the frame opposite to the open side of the frame.

According to this configuration, the angle of the reflecting mirror can be adjusted from a side of the frame opposite to the side through which the light beam is let out. Thus, adjustment of the angle of the reflecting mirror can be made more easily during assembly of the scanning optical device.

The above-described scanning optical device may be configured such that the base wall has a first opening elongated in a main scanning direction of the light beam and configured to allow a reflection surface of the reflecting mirror to be exposed toward the open side of the frame.

The above-described scanning optical device may be configured such that the reflecting mirror overlaps the second scan lens as viewed in the first direction.

The above-described scanning optical device may be configured such that the angle of the reflecting mirror with respect to the seating surface is fixed by a photo-curable resin.

The above-described scanning optical device may be configured such that the seating surface includes a protrusion that protrudes toward the reflecting mirror and is in contact with the reflecting mirror to serve as a supporting point when the angle of the reflecting mirror is adjusted.

This additional configuration would make it easier to adjust the angle of the reflecting mirror.

The above-described scanning optical device may be configured to further comprise a spring configured to press the reflecting mirror against the seating surface, and the spring may have a second opening that allows light for curing the photo-curable resin to pass therethrough.

The above-described scanning optical device may be configured to further comprise a supporting member having the seating surface, the supporting member being attached to the frame.

According to this configuration, the reflecting mirror can be removed without adversely affecting the frame if adjustment of the angle of the reflecting mirror has ended in failure when assembling the scanning optical device. Thus, attachment of the first reflecting mirror can be performed over again if adjustment of the angle of the reflecting mirror has ended in failure when assembling the scanning optical device.

In the meantime, the scanning optical device known in the art is configured such that the reflecting mirror is disposed closer, than a last scan lens, to a photosensitive drum on which an image is to be formed by a light beam. Thus, a distance from the last scan lens to the photosensitive drum is long and magnification in the sub scanning direction should be made relatively greater. As a result, due to such greater magnification in the sub scanning direction, the sensitivity of the scanning optical device to tolerances in the sub scanning direction would become undesirably greater.

It would be desirable to reduce sensitivity of the scanning optical device to tolerances.

Thus, in another aspect, a scanning optical device disclosed herein comprises a light source, a polygon mirror, a motor, a first scanning optical system, a second scanning optical system, a third scanning optical system, a fourth scanning optical system, and a frame.

The light source emits a light beam. The polygon mirror deflects the light beam emitted from the light source. The motor rotates the polygon mirror about a rotation axis parallel to a first direction. The first scanning optical system is located on one side of the polygon mirror at a distance from the polygon mirror in a second direction perpendicular to the first direction. The first scanning optical system is configured to receive the light beam deflected by the polygon mirror and direct the light beam from a first position toward a first image plane. The second scanning optical system is located on the one side of the polygon mirror at a distance from the polygon mirror in the second direction. The second scanning optical system is configured to receive the light beam deflected by the polygon mirror and direct the light beam toward a second image plane, from a second position located closer, than the first position, to the polygon mirror. The third scanning optical system is located on another side of the polygon mirror at a distance from the polygon mirror in a direction opposite to the second direction. The third scanning optical system being configured to receive the light beam deflected by the polygon mirror and direct the light beam from a third position toward a third image plane. The fourth scanning optical system is located on the another side of the polygon mirror at a distance from the polygon mirror in the direction opposite to the second direction. The fourth scanning optical system is configured to receive the light beam deflected by the polygon mirror and direct the light beam toward a fourth image plane, from a fourth position located farther, than the third position, from the polygon mirror. The first scanning optical system, the second scanning optical system, the third scanning optical system, and the fourth scanning optical system are fixed to the frame. The frame comprises a base wall and a side wall. The motor is fixed to the base wall. The side wall protrudes from the base wall in the first direction along an outer edge of the base wall to form an open side of the frame that opens in the first direction.

Each of the first scanning optical system, the second scanning optical system, the third scanning optical system, and the fourth scanning optical system comprises a first scan lens, at least one reflecting mirror, and a second scan lens. The light beam deflected by the polygon mirror passes through the first scan lens. The at least one reflecting mirror is arranged to reflect the light beam having passed through the first scan lens. The light beam reflected by the at least one reflecting mirror passes through the second scan lens.

The second scan lens is arranged apart from the base wall in the first direction to receive a light beam traveling in a direction away from the base wall toward the second scan lens.

According to this configuration, by locating the second scan lens at a position closest to the image plane, the sensitivity to tolerances can be reduced.

The above-described scanning optical device may be configured such that the respective second scan lenses of the first scanning optical system, the second scanning optical system, the third scanning optical system, and the fourth scanning optical system are aligned along a straight line parallel to the second direction.

According to this configuration, the distances from the second scan lenses to the respective image planes can be made equal.

The above-described scanning optical device may be configured such that the first scan lens of the first scanning optical system and the first scan lens of the second scanning optical system are comprised of a single common lens, and the first scan lens of the third scanning optical system and the first scan lens of the fourth scanning optical system are comprised of a single common lens.

According to this configuration, by providing a common lens that serves as two first scan lenses, the scanning optical device can be downsized.

The above-described scanning optical device may be configured such that the first scan lens and the second scan lens, in at least one of the scanning optical systems, overlap each other as viewed in the first direction.

According to this configuration, the second scan lens of at least one scanning optical system can be located near the polygon mirror.

The above-described scanning optical device may be configured such that the at least one reflecting mirror includes a first reflecting mirror arranged to reflect a light beam toward the second scan lens, and in the second scanning optical system and the third scanning optical system, the first scan lens is located between the polygon mirror and a path of a light beam traveling from the first reflecting mirror toward the second scan lens.

According to this configuration, the distance between the polygon mirror and the first scan lens can be made shorter.

The above-described scanning optical device may be configured such that each of the first scanning optical system and the fourth scanning optical system includes a single first reflecting mirror as the at least one reflecting mirror, the first reflecting mirror being arranged to reflect a light beam toward the second scan lens, and each of the second scanning optical system and the third scanning optical system includes a single first reflecting mirror and a single second reflecting mirror, as the at least one reflecting mirror, the first reflecting mirror being arranged to reflect a light beam toward the second scan lens, and the second reflecting mirror being arranged to reflect the light beam deflected by the polygon mirror toward the first reflecting mirror.

According to this configuration, the number of reflecting mirrors can be reduced.

The above-described scanning optical device may be configured such that the frame comprises a first wall on which the second scan lens is supported, the first wall protruding from the base wall in the first direction.

According to this configuration, the second scan lenses can be more accurately positioned relative to the polygon mirror.

The above-described scanning optical device may be configured such that the frame comprises a second wall provided apart from each end of the second scan lens in the longitudinal direction of the second scan lens.

The above-described scanning optical device may be configured such that the frame comprises a third wall extending in a direction perpendicular to the first direction to connect the first wall and the second wall.

According to this configuration, the strength of the first wall supporting the second scan lens can be increased.

The above-described scanning optical device may be configured such that the first wall is configured to support a plurality of the second scan lenses.

According to this configuration, sensitivity to tolerances can be reduced.

The scanning optical device known in the art is configured such that all of the second scan lenses are offset in the same direction with respect to the respective light beams let out from the second scan lenses. In this configuration, however, less space is available between the second scan lens located on one side of the polygon mirror closer to the polygon mirror, and the second scan lens located on the other side of the polygon mirror closer to the polygon mirror. Thus, it has been difficult to restrain upsizing of the scanning optical device.

It would be desirable to restrain upsizing of the scanning optical device.

Thus, in yet another aspect, the scanning optical device disclosed herein comprises a light source, a polygon mirror, a motor, a first scanning optical system, a second scanning optical system, a third scanning optical system, and a fourth scanning optical system.

The light source emits a light beam. The polygon mirror deflects the light beam emitted from the light source. The motor rotates the polygon mirror about a rotation axis parallel to a first direction. The first scanning optical system is located on one side of the polygon mirror at a distance from the polygon mirror in a second direction perpendicular to the first direction. The first scanning optical system is configured to receive the light beam deflected by the polygon mirror and direct the light beam toward a first image plane from a first position. The second scanning optical system is located on the one side of the polygon mirror at a distance from the polygon mirror in the second direction. The second scanning optical system is configured to receive the light beam deflected by the polygon mirror and direct the light beam toward a second image plane from a second position located closer, than the first position, to the polygon mirror in the second direction. The third scanning optical system is located on another side of the polygon mirror at a distance from the polygon mirror in a direction opposite to the second direction. The third scanning optical system is configured to receive the light beam deflected by the polygon mirror and direct the light beam from a third position toward a third image plane. The fourth scanning optical system is located on the another side of the polygon mirror at a distance from the polygon mirror in the direction opposite to the second direction. The fourth scanning optical system is configured to receive the light beam deflected by the polygon mirror and direct the light beam toward a fourth image plane, from a fourth position located farther, than the third position, from the polygon mirror in the second direction.

Each of the first scanning optical system, the second scanning optical system, the third scanning optical system, and the fourth scanning optical system comprises a first scan lens, at least one reflecting mirror, and a second scan lens. The light beam deflected by the polygon mirror passes through the first scan lens. The at least one reflecting mirror is arranged to reflect the light beam having passed through the first scan lens. The second scan lens concentrates the light beam reflected by the at least one reflecting mirror in the sub scanning direction.

In the first scanning optical system and the second scanning optical system, the centers of the respective second scan lenses in the sub scanning direction are each offset in the second direction with respect to the light beams passing through the respective second scan lenses.

In the third scanning optical system and the fourth scanning optical system, the centers of the respective second scan lenses in the sub scanning direction are each offset in the direction opposite to the second direction with respect to the light beams passing through the respective second scan lenses.

According to this configuration, since the centers of the second scan lenses of the first scanning optical system and the second scanning optical system are offset in a direction opposite to the direction in which the centers of the second scan lenses of third scanning optical system and the fourth scanning optical system are offset, the distance between the second scan lens of the second scanning optical system and the second scan lens of the third scanning optical system can be made greater. As a result, the distance between the second scan lens of the second scanning optical system and the second scan lens of the third scanning optical system can be made greater without making the distances between each of the light beams greater. Thus, the upsizing of the scanning optical device can be restrained.

The above-described scanning optical device may be configured such that the respective second scan lenses of the first scanning optical system, the second scanning optical system, the third scanning optical system, and the fourth scanning optical system are aligned along a straight line parallel to the second direction.

According to this configuration, the distances from the second scan lenses to the respective image planes can be made equal.

The above-described scanning optical device may be configured such that the first scan lens of the first scanning optical system and the first scan lens of the second scanning optical system are comprised of a single common lens, and the first scan lens of the third scanning optical system and the first scan lens of the fourth scanning optical system are comprised of a single common lens.

According to this configuration, by providing a common lens that serves as two first scan lenses, the scanning optical device can be downsized.

The above-described scanning optical device may be configured such that each of the first scanning optical system and the fourth scanning optical system includes a single first reflecting mirror as the at least one reflecting mirror, the first reflecting mirror being arranged to reflect a light beam toward the second scan lens, and each of the second scanning optical system and the third scanning optical system includes a single first reflecting mirror and a single second reflecting mirror, as the at least one reflecting mirror, the first reflecting mirror being arranged to reflect a light beam toward the second scan lens, and the second reflecting mirror being arranged to reflect the light beam deflected by the polygon mirror toward the first reflecting mirror.

According to this configuration, the number of reflecting mirrors can be reduced.

The above-described scanning optical device may be configured to further comprise a frame to which the motor, the first scanning optical system, the second scanning optical system, the third scanning optical system, and the fourth scanning optical system are fixed, the frame including a base wall to which the motor is fixed, and a side wall that protrudes from the base wall in the first direction along an outer edge of the base wall to form an open side of the frame that opens in the first direction, wherein light beams reflected by the polygon mirror travel obliquely with respect to a plane perpendicular to the first direction and intersecting with the polygon mirror. The first scanning optical system and the fourth scanning optical system may be configured such that the light beams reflected by the polygon mirror travel obliquely at an inclination to one side of the plane in a direction opposite to the first direction. The second scanning optical system and the third scanning optical system may be configured such that the light beams deflected by the polygon mirror travel obliquely at an inclination to another side of the plane in the first direction.

The above-described scanning optical device may be configured such that the optical surfaces of the second scan lenses of each of the first scanning optical system, the second scanning optical system, the third scanning optical system, and the fourth scanning optical system are symmetrical with respect to the sub scanning direction.

The above-described scanning optical device may be configured such that an angle formed between a line parallel to the second direction and each straight line parallel to the sub scanning direction of a corresponding second scan lens of the first scanning optical system or the second scanning optical system are different from an angle formed between a line parallel to the second direction and each straight line parallel to the sub scanning direction of a corresponding second scan lens of the third scanning optical system or the fourth scanning optical system.

According to this configuration, the light beam can be let out through the second scan lens at an angle with respect to the first direction

The above and other aspects, their advantages and further features will become more apparent by describing in detail illustrative, non-limiting embodiments thereof with reference to the accompanying drawings briefly described below:

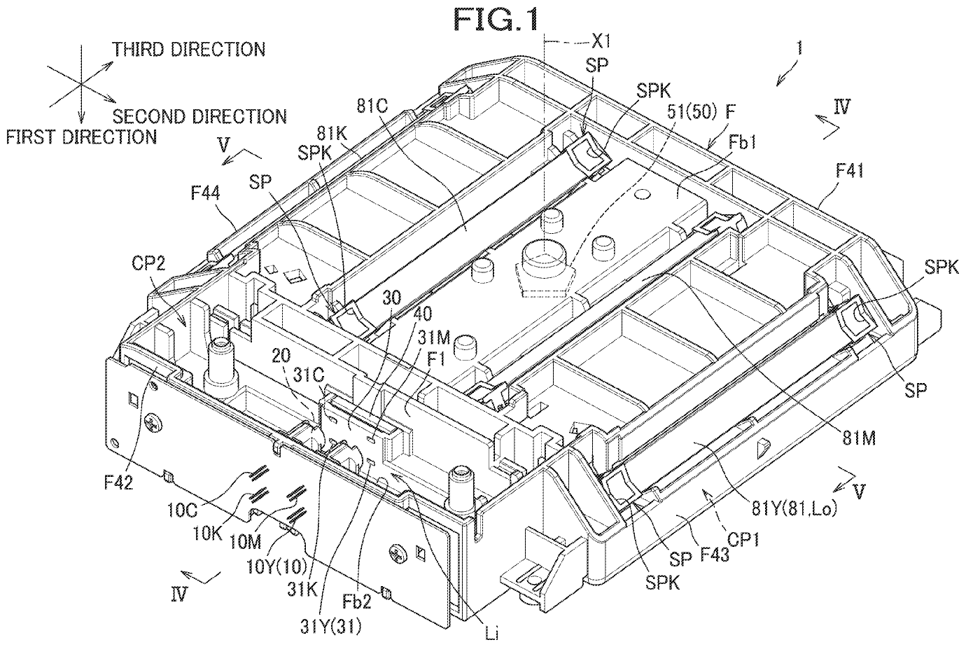

FIG. 1 is a perspective view of a scanning optical device, showing one side thereof facing in a direction opposite to a first direction.

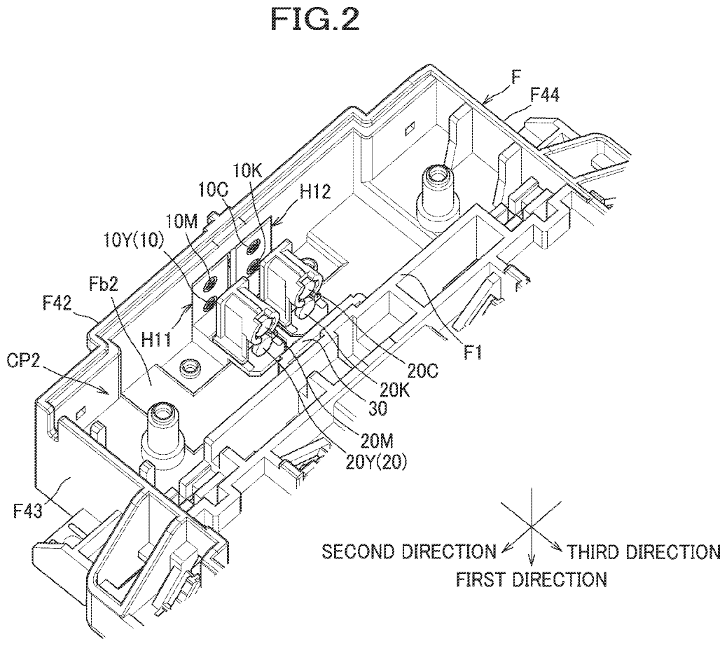

FIG. 2 is a perspective view showing structures at and around coupling lenses.

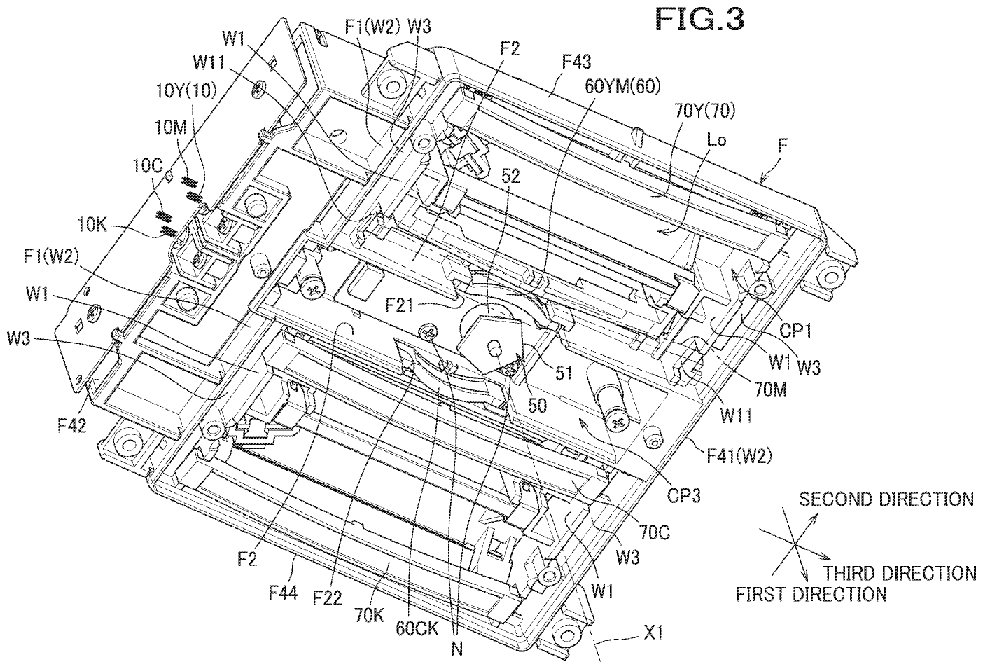

FIG. 3 is a perspective view of the scanning optical device, showing the other side thereof facing in the first direction.

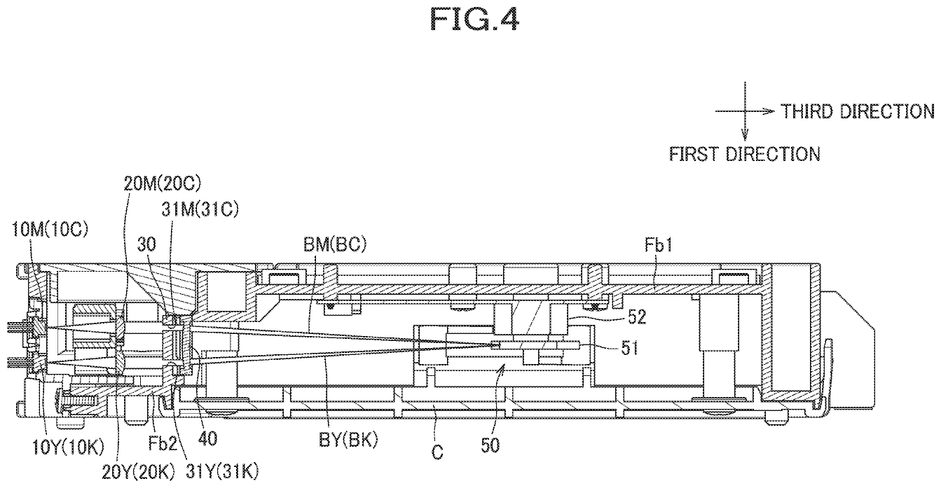

FIG. 4 is a cross-sectional view taken along a line IV-IV of FIG. 1.

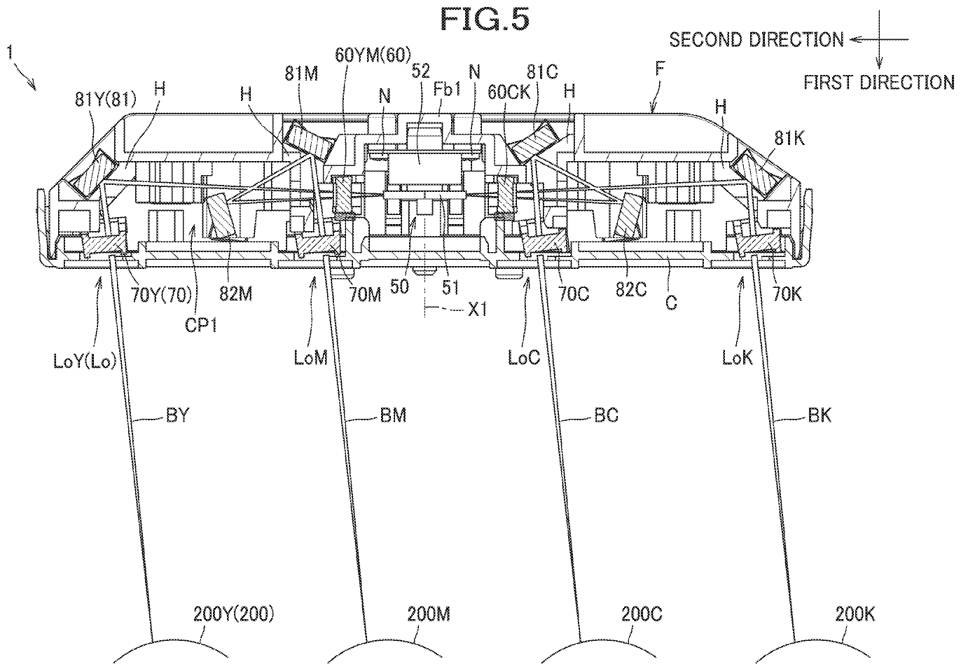

FIG. 5 is a cross-sectional view taken along a line V-V of FIG. 1.

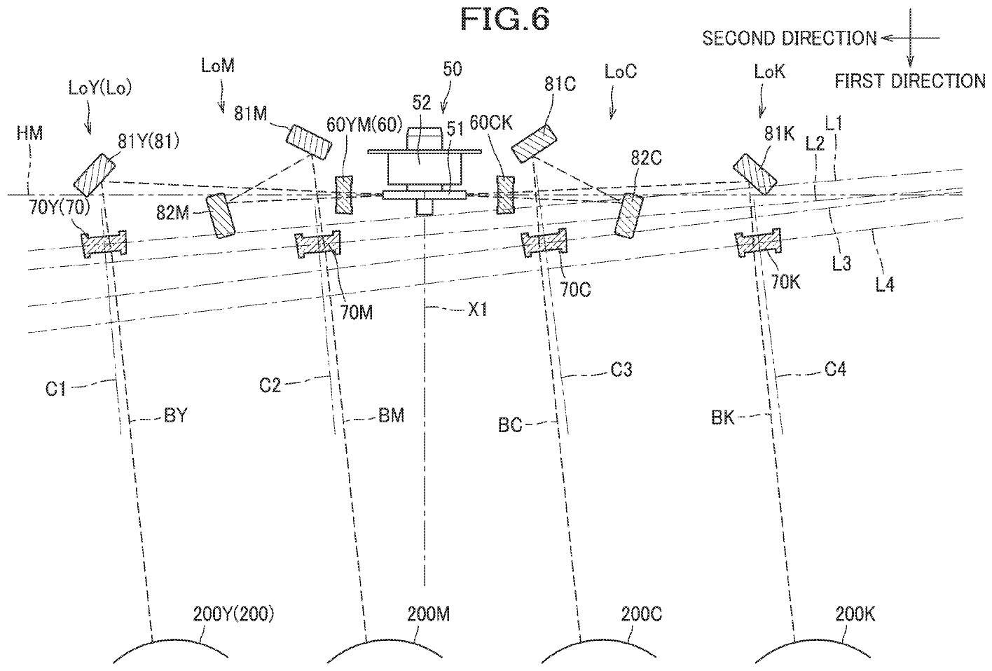

FIG. 6 is an illustration showing the specific positions and angles of second scan lenses shown in FIG. 5.

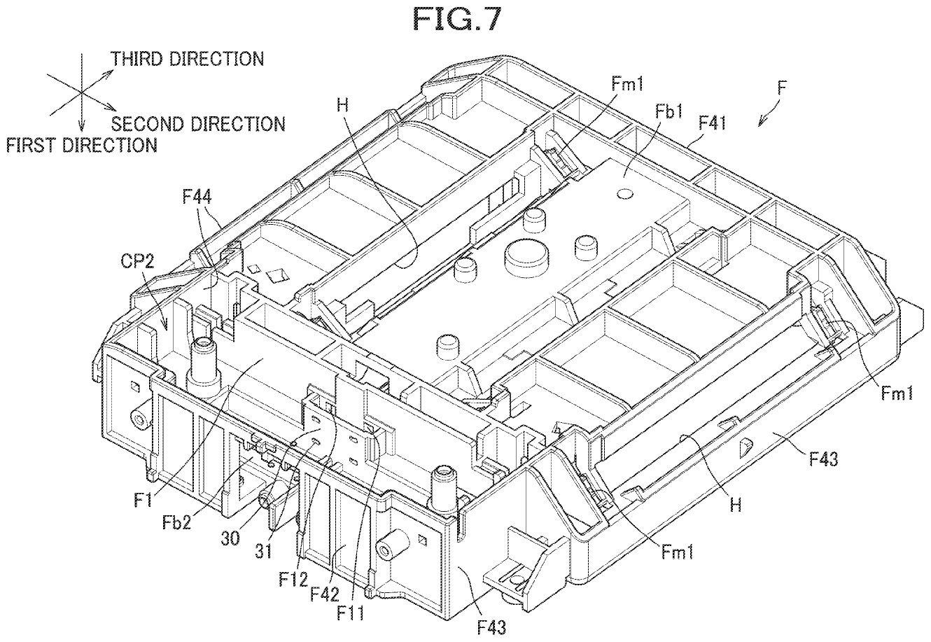

FIG. 7 is a perspective view of a frame, showing one side thereof facing in the direction opposite to the first direction.

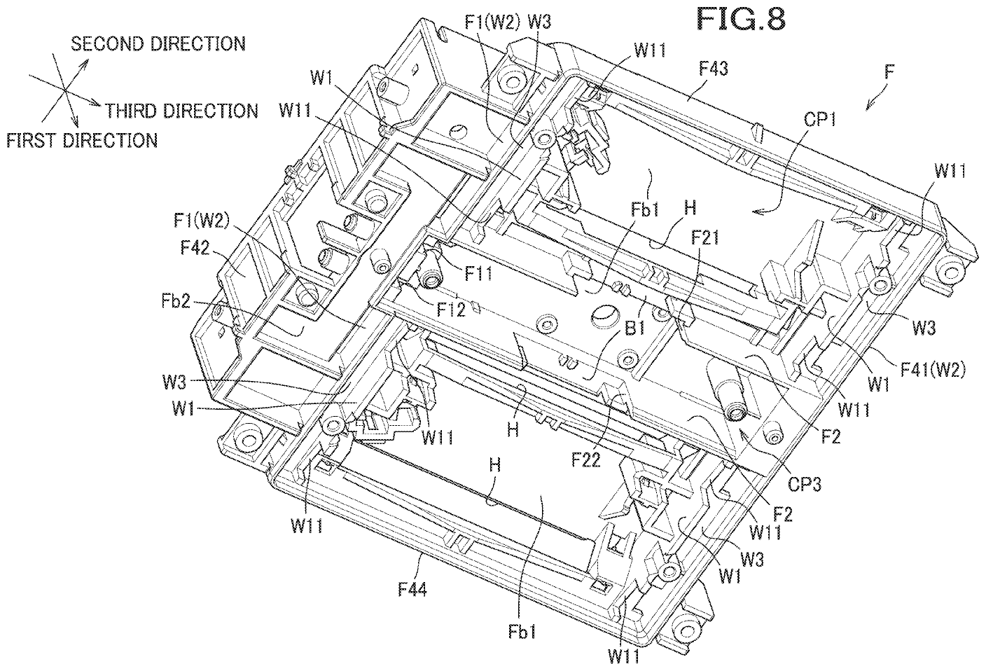

FIG. 8 is a perspective view of the frame, showing the other side thereof facing in the first direction.

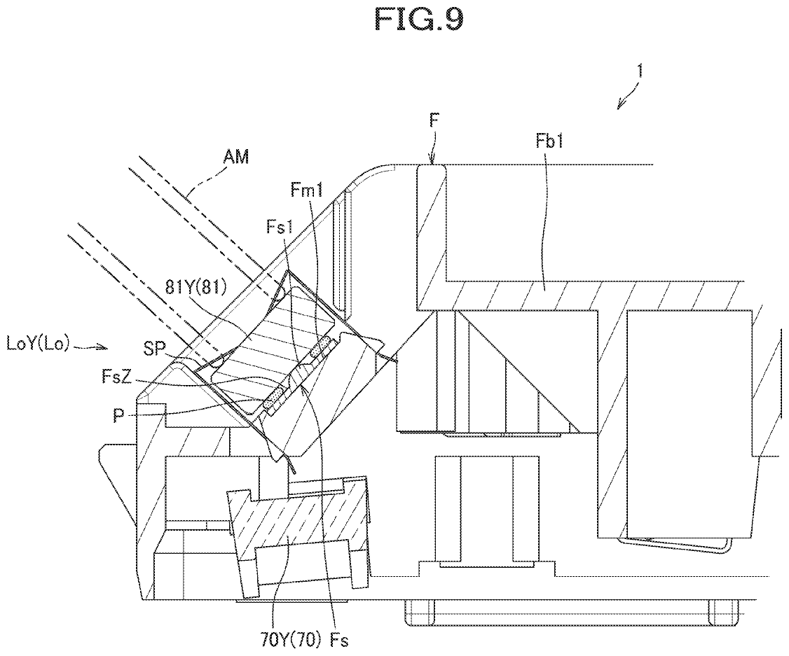

FIG. 9 is a cross-sectional view of a structure for attaching a reflecting mirror to the frame.

As shown in FIGS. 1 to 3, a scanning optical device 1 comprises a frame F, an illumination optical system Li, a deflector 50, and a scanning optical system Lo. The scanning optical device 1 is applied to an electrophotographic image forming apparatus. In the following description, a direction parallel to a rotation axis X1 of a polygon mirror 51 shown in FIG. 3 will be referred to as “first direction”. A direction in which the polygon mirror 51 and first scan lenses 60 are arranged as shown in FIG. 3, perpendicular to the first direction, will be referred to as “second direction”. Further, a direction perpendicular to the first direction and to the second direction will be referred to as “third direction”. In the scanning optical system Lo, the third direction corresponds to a main scanning direction. Each of the arrows in the drawings points in a corresponding direction.

As shown in FIG. 2, the illumination optical system Li comprises four semiconductor lasers 10, four coupling lenses 20, a diaphragm 30, and a condenser lens 40. The semiconductor lasers 10 and the coupling lenses 20 are an example of a light source.

The semiconductor laser 10 is a device which emits light. One semiconductor laser 10 is provided for each of four photosensitive drums 200 (see FIG. 5) to be scanned with and exposed to light by the scanning optical device 1. A toner image of a different color is formed on each photosensitive drum 200.

In this example, the first color is “yellow (Y)”, the second color is “magenta (M)”, the third color is “cyan (C)”, and the fourth color is black (K). In the following description, “first” may be added to the beginning of a name of a part and “Y” may be added to the end of a reference character of the part to designate the part corresponding to the first color. Similarly, “second”, “third”, or “fourth” may be added to the beginning of a name of a corresponding part and “M”, “C”, or “K” may be added to the end of a corresponding reference character, to designate parts respectively corresponding to the second color, the third color and the fourth color.

The first semiconductor laser 10Y is aligned with and spaced apart from the second semiconductor laser 10M in the first direction. The first semiconductor laser 10Y is located at a distance from the second semiconductor laser 10M in the first direction.

The third semiconductor laser 10C is aligned with and spaced apart from the second semiconductor laser 10M in the direction opposite to the second direction. The third semiconductor laser 10C is located at a distance from the second semiconductor laser 10M in the direction opposite to the second direction. The fourth semiconductor laser 10K is aligned with and spaced apart from the third semiconductor laser 10C in the first direction, and aligned with and spaced apart from the first semiconductor laser 10Y in the direction opposite to the second direction.

The coupling lenses 20 are lenses for converting light received from the semiconductor lasers 10 to light beams. Each of the coupling lenses 20Y, 20M, 20C, 20K corresponds to a different color and faces a corresponding semiconductor laser 10Y, 10M, 10C, 10K.

As shown in FIG. 1, the diaphragm 30 is formed integrally with the frame F and has aperture stops 31 through which light beams from the coupling lenses 20 pass. The diaphragm 30 is located between the coupling lenses 20 and the condenser lens 40.

The condenser lens 40 is a lens through which a light beam from each of the coupling lenses 20 is concentrated on the polygon mirror 51 in the sub scanning direction. The condenser lens 40 and the coupling lenses 20 are located on opposite sides of the diaphragm 30.

As shown in FIG. 3, the deflector 50 comprises a polygon mirror 51 and a motor 52. The polygon mirror 51 deflects a light beam emitted from each light source. Specifically, the polygon mirror 51 deflects a light beam which has passed through the condenser lens 40, in the main scanning direction. The polygon mirror 51 has five mirror surfaces disposed equidistantly from the rotation axis X1. The motor 52 rotates the polygon mirror 51 about the rotation axis X1 parallel to the first direction. The motor 52 is fixed to the frame F.

The scanning optical system Lo is an optical system that directs a light beam deflected by the deflector 50 on a surface (i.e., image plane) of the photosensitive drum 200 to form an image thereon. The scanning optical system Lo is fixed to the frame F. As shown in FIG. 5, the scanning optical system Lo comprises a first scanning optical system LoY corresponding to yellow, a second scanning optical system LoM corresponding to magenta, a third scanning optical system LoC corresponding to cyan, and a fourth scanning optical system LoK corresponding to black.

The first scanning optical system LoY and the second scanning optical system LoM are located on one side of the polygon mirror 51 at distances from the polygon mirror 51 in the second direction. The third scanning optical system LoC and the fourth scanning optical system LoK are located on the other side of the polygon mirror 51 at distances from the polygon mirror 51 in the direction opposite to the second direction. Light beams deflected in the main scanning direction by the polygon mirror 51 enter respective scanning optical systems LoY, LoM, LoC, LoK.

Each of the first scanning optical system LoY, the second scanning optical system LoM, the third scanning optical system LoC, and the fourth scanning optical system LoK includes a first scan lens, at least one reflecting mirror, and a second scan lens. The light beam deflected by the polygon mirror 51 passes through the first scan lens. The at least one reflecting mirror is arranged to reflect the light beam having passed through the first scan lens. The second scan lens concentrates the light beam reflected by the at least one reflecting mirror, in the sub scanning direction.

In this example, the first scan lens of the first scanning optical system LoY and the first scan lens of the second scanning optical system LoM are comprised of a single common lens 60YM. Similarly, the first scan lens of the third scanning optical system LoC and the first scan lens of the fourth scanning optical system LoK are comprised of a single common lens 60CK.

In this example, the first scanning optical system LoY and the fourth scanning optical system LoK each comprise a single reflecting mirror. The second scanning optical system LoM and the third scanning optical system LoC each comprise two reflecting mirrors.

The first scanning optical system LoY directs a light beam BY deflected by the polygon mirror 51 toward a first image plane of a first photosensitive drum 200Y from a first position. The first position is a position at which the second scan lens 70Y is located. The first scanning optical system LoY comprises a first scan lens 60YM, a second scan lens 70Y, and a first reflecting mirror 81Y.

The first scan lens 60YM is a lens that causes the light beam BY deflected by the deflector 50 to be refracted and focused in the main scanning direction to form an image on the first image plane. The first scan lens 60YM has a f-theta characteristic such that the light beam deflected at a constant angular velocity by the deflector 50 is converted into a light beam that scans the image surface at a constant linear velocity. The first scan lens 60YM is the scan lens of the first scanning optical system LoY closest to the polygon mirror 51.

The first reflecting mirror 81Y is a mirror that reflects the light beam BY from the first scan lens 60YM toward the second scan lens 70Y. The second scan lens 70Y is a lens that causes the light beam BY reflected by the first reflecting mirror 81Y to be refracted and focused in the sub scanning direction to form an image on the first image plane. The first reflecting mirror 81Y is arranged to overlap the second scan lens 70Y as viewed in the first direction. The second scan lens 70Y is located on one side of the polygon mirror 51 at a distance from the polygon mirror 51 in the first direction. The second scan lens 70Y is the scan lens of the first scanning optical system LoY closest to the first image plane.

The second scanning optical system LoM directs a light beam BM deflected by the polygon mirror 51 toward a second image plane of a second photosensitive drum 200M. The second scanning optical system LoM directs the light beam BM toward the second image plane of the second photosensitive drum 200M from a second position located closer, than the first position, to the polygon mirror 51 in the direction opposite to the second direction. The second position is a position at which the second scan lens 70M is located. The second scanning optical system LoM comprises the first scan lens 60YM, a second scan lens 70M, a first reflecting mirror 81M, and a second reflecting mirror 82M.

The first scan lens 60YM of the second scanning optical system LoM is located between the polygon mirror 51 and the path of the light beam BM traveling from the first reflecting mirror 81M toward the second scan lens 70M.

The second reflecting mirror 82M is a mirror that reflects the light beam BM from the first scan lens 60YM toward the first reflecting mirror 81M. The first reflecting mirror 81M is a mirror that reflects the light beam BM from the second reflecting mirror 82M toward the second scan lens 70M. The first reflecting mirror 81M is arranged to overlap the second scan lens 70M as viewed in the first direction. The second scan lens 70M is a lens that causes the light beam BM reflected by the first reflecting mirror 81M to be refracted and focused in the sub scanning direction to form an image on the second image plane. In the second scanning optical system LoM, the first scan lens 60YM and the second scan lens 70M are arranged to overlap each other as viewed in the first direction. The second scan lens 70M is located on one side of the polygon mirror 51 at a distance from the polygon mirror 51 in the first direction. The second scan lens 70M is the scan lens of the second scanning optical system LoM closest to the second image plane.

The third scanning optical system LoC directs a light beam BC deflected by the polygon mirror 51 toward a third image plane of a third photosensitive drum 200C from a third position. The third position is a position at which the second scan lens 70C is located. The third scanning optical system LoC comprises a first scan lens 60CK, a second scan lens 70C, a first reflecting mirror 81C, and a second reflecting mirror 82C.

The first scan lens 60CK is a lens that causes the light beam BC deflected by the deflector 50 to be refracted and focused in the main scanning direction to form an image on the third image plane. The first scan lens 60CK has a f-theta characteristic such that the light beam deflected at a constant angular velocity by the deflector 50 is converted into a light beam that scans the image plane at a constant linear velocity. The first scan lens 60CK is the scan lens of the third scanning optical system LoC closest to the polygon mirror 51. The first scan lens 60CK of the third scanning optical system LoC is located between the polygon mirror 51 and the path of the light beam BC traveling from the first reflecting mirror 81C toward the second scan lens 70C.

The second reflecting mirror 82C is a mirror that reflects the light beam BC from the first scan lens 60CK toward the first reflecting mirror 81C. The first reflecting mirror 81C is a mirror that reflects the light beam BC from the second reflecting mirror 82C toward the second scan lens 70C. The first reflecting mirror 81C is arranged to overlap the second scan lens 70C as viewed in the first direction. The second scan lens 70C is a lens that causes the light beam BC reflected by the first reflecting mirror 81C to be refracted and focused in the sub scanning direction to form an image on the third image plane. The second scan lens 70C is located on the other side of the polygon mirror 51 at a distance from the polygon mirror 51 in the direction opposite to the second direction. The second scan lens 70C is the scan lens of the third scanning optical system LoC closest to the third image plane.

The fourth scanning optical system LoK directs a light beam BK deflected by the polygon mirror 51 toward a fourth image plane of a fourth photosensitive drum 200K. The fourth scanning optical system LoK directs the light beam BK toward the fourth image plane of the fourth photosensitive drum 200K from a fourth position located farther, than the third position, from the polygon mirror 51 in the direction opposite to the second direction. The fourth position is a position at which the second scan lens 70K is located. The fourth scanning optical system LoK comprises the first scan lens 60CK, a second scan lens 70K, and a first reflecting mirror 81K.

The first scan lens 60CK is a lens that causes the light beam BK deflected by the deflector 50 to be refracted and focused in the main scanning direction to form an image on the fourth image plane. The first scan lens 60CK has a f-theta characteristic such that the light beam deflected at a constant angular velocity by the deflector 50 is converted into a light beam that scans the image plane at a constant linear velocity. The first scan lens 60CK is the scan lens of the fourth scanning optical system LoK closest to the polygon mirror 51.

The first reflecting mirror 81K is a mirror that reflects the light beam BK from the first scan lens 60CK toward the second scan lens 70K. The first reflecting mirror 81K is arranged to overlap the second scan lens 70K as viewed in the first direction. The second scan lens 70K is a lens that causes the light beam BK reflected by the first reflecting mirror 81K to be refracted and focused in the sub scanning direction to form an image on the fourth image plane. The second scan lens 70K is located on the other side of the polygon mirror 51 at a distance from the polygon mirror 51 in the direction opposite to the second direction. The second scan lens 70K is the scan lens of the fourth scanning optical system LoK closest to the fourth image plane.

Respective second scan lenses 70Y, 70M, 70C, 70K of the first scanning optical system LoY, the second scanning optical system LoM, the third scanning optical system LoC, and the fourth scanning optical system LoK are aligned along a straight line parallel to the second direction. In other words, the second scan lenses 70Y, 70M, 70C, 70K are arranged to at least partially overlap each other as viewed in the second direction.

As shown in FIG. 6, the light beams reflected by the polygon mirror 51 travel obliquely at an inclination to one side of a plane HM perpendicular to the first direction and intersecting with reflection points of the polygon mirror 51. In the first scanning optical system LoY and the fourth scanning optical system LoK, the light beams deflected by the polygon mirror 51 travel obliquely at an inclination to one side of the plane HM in a direction opposite to the first direction (upward in FIG. 6). In the second scanning optical system LoM and the third scanning optical system LoC, the light beams deflected by the polygon mirror 51 travel obliquely at an inclination to one side of the plane HM in the first direction (downward in FIG. 6).

The optical surfaces of the respective second scan lenses 70Y, 70M, 70C, 70K of the first scanning optical system LoY, the second scanning optical system LoM, the third scanning optical system LoC, and the fourth scanning optical system LoK are symmetrical with respect to the sub scanning direction.

In the first scanning optical system LoY and the second scanning optical system LoM, the centers C1, C2 of the optical surfaces of the respective second scan lenses 70Y, 70M in the sub scanning direction are offset in the second direction (leftward in FIG. 6) with respect to paths of light beams BY, BM passing through the respective second scan lenses 70Y, 70M.

On the other hand, in the third scanning optical system LoC and the fourth scanning optical system LoK, the centers C3, C4 of the optical surfaces of the respective second scan lenses 70C, 70K in the sub scanning direction are offset in the direction opposite to the second direction (rightward in FIG. 6) with respect to paths of light beams BC, BK passing through the respective second scan lenses 70C, 70K.

In other words, each of the second scan lenses 70Y, 70M of the first scanning optical system LoY and the second scanning optical system LoM and each of the second scan lenses 70C, 70K of the third scanning optical system LoC and the fourth scanning optical system LoK are offset in directions opposite to each other.

A straight line L1 parallel to the sub scanning direction of the second scan lens 70Y of the first scanning optical system LoY is parallel to a straight line L2 parallel to the sub scanning direction of the second scan lens 70M of the second scanning optical system LoM. A straight line L3 parallel to the sub scanning direction of the second scan lens 70C of the third scanning optical system LoC is parallel to a straight line L4 parallel to the sub scanning direction of the second scan lens 70K of the fourth scanning optical system LoK.

An angle which each of the straight lines L1, L2 parallel to the sub scanning direction of a corresponding second scan lens 70Y, 70M of the first scanning optical system LoY or the second scanning optical system LoM form with a line parallel to the second direction is different from an angle which each of the straight lines L3, L4 parallel to the sub scanning direction of a corresponding second scan lens 70C, 70K of the third scanning optical system LoC or the fourth scanning optical system LoK form with the line parallel to the second direction.

Specifically, an angle which each of the straight lines L3, L4 parallel to the sub scanning direction of a corresponding second scan lens 70C, 70K of the third scanning optical system LoC or the fourth scanning optical system LoK form with the plane HM extending in the second direction is greater than an angle which each of the straight lines L1, L2 parallel to the sub scanning direction of a corresponding second scan lens 70Y, 70M of the first scanning optical system LoY or the second scanning optical system LoM form with the plane HM extending in the second direction.

As shown in FIG. 4, light emitted from each of the semiconductor lasers 10Y to 10K is converted to a light beam BY to BK when passing through a corresponding coupling lens 20Y to 20K. The beams BY to BK pass through respective aperture stops 31Y to 31K of the diaphragm 30, and then through the condenser lens 40, and strike a reflecting surface of the polygon mirror 51. The condenser lens 40 is a lens through which all of the beams BY, BM, BC, BK pass. The condenser lens 40 has a cylindrical incident-side surface and a flat exit-side surface.

As shown in FIG. 5, the polygon mirror 51 deflects the light beams BY to BK toward the respective scanning optical systems LoY to LoK. The light beam BY directed toward the first scanning optical system LoY passes through the first scan lens 60YM and is reflected by the first reflecting mirror 81Y toward the second scan lens 70Y. The light beam BY then passes through the second scan lens 70Y and is directed to the first image plane. The light beam BY is let out through the second scan lens 70Y at a predetermined angle with respect to the first direction toward the first image plane. The light beam BY is focused on a surface of the first photosensitive drum 200Y and scans the surface of the first photosensitive drum 200Y in the main scanning direction to form an image thereon.

The light beam BM directed toward the second scanning optical system LoM passes through the first scan lens 60YM and is reflected by the second reflecting mirror 82M and the first reflecting mirror 81M. The light beam BM then passes through the second scan lens 70M and is directed to the second image plane. The light beam BM is let out through the second scan lens 70M at a predetermined angle with respect to the first direction toward the second image plane. The light beam BM is focused on a surface of the second photosensitive drum 200M and scans the surface of the second photosensitive drum 200M in the main scanning direction to form an image thereon. Similarly, each of the light beams BC, BK is directed by a corresponding scanning optical system LoC, LoK toward a corresponding image plane, and focused on a corresponding photosensitive drum 200C, 200K and scans the corresponding photosensitive drum 200C, 200K in the main scanning direction to form an image thereon.

As shown in FIGS. 3 and 5, the polygon mirror 51, the motor 52, the first scanning optical system LoY, the second scanning optical system LoM, the third scanning optical system LoC, and the fourth scanning optical system LoK are fixed to the frame F. The frame F is made of plastic and is molded in one piece. The frame F includes a first recess CP1 shown in FIG. 8 and a second recess CP2 shown in FIG. 7. The first recess CP1 opens in the first direction. The second recess CP2 opens in the direction opposite to the first direction. As shown in FIG. 5, the deflector 50 and a part of the scanning optical system Lo is located in the first recess CP1. Specifically, members of the scanning optical system Lo excluding the first reflecting mirrors 81 are located in the first recess CP1. As shown in FIG. 2, the coupling lenses 20, the diaphragm 30, and the condenser lens 40 (see FIG. 1) are located in the second recess CP2.

As shown in FIG. 5, the scanning optical device 1 further comprises a cover C. The cover C covers sides of the deflector 50 and the first base wall Fb1 facing in the first direction and is fixed to the frame F by a screw. Specifically, the cover C covers an opening of the first recess CP1. The first scan lenses 60YM, 60CK and the second scan lenses 70Y, 70M, 70C. 70K are located in the first recess CP1 between the first base wall Fb1 and the cover C.

As shown in FIGS. 7 and 8, the frame F includes a first base wall Fb1 as an example of a base wall located at the bottom of the first recess CP1, and a second base wall Fb2 located at the bottom of the second recess CP2.

The first base wall Fb1 and the second base wall Fb2 are walls nonparallel to the first direction. Specifically, the first base wall Fb1 and the second base wall Fb2 are walls of which thicknesses are dimensions as measured in the first direction. That is, the first base wall Fb1 and the second base wall Fb2 are walls with surfaces perpendicular to the first direction.

The second base wall Fb2 is located on one side of the first base wall Fb1 at a distance from the first base wall Fb1 in the first direction. As shown in FIG. 5, the deflector 50 and the part of scanning optical system Lo described above are directly or indirectly attached to the first base wall Fb1 in the direction opposite to the first direction. Thus, the deflector 50 and the part of the scanning optical system Lo are located on one side of the first base wall Fb1 at distances from the first base wall Fb1 in the first direction. In this example, the deflector 50, i.e., the polygon mirror 51 and the motor 52, is fixed to the first base wall Fb1 by a plurality of screws N.

As shown in FIG. 5, the light beams BY, BM, BC, BK traveling from the first base wall Fb1 toward the second scan lenses 70Y, 70M, 70C, 70K of the respective scanning optical systems LoY, LoM, LoC, LoK are let out through the second scan lenses 70Y, 70M, 70C, 70K.

As shown in FIG. 2, the semiconductor lasers 10, the coupling lenses 20, and the diaphragm 30 are each located on one side of the second base wall Fb2 at distances from the second base wall Fb2 in the direction opposite to the first direction. Further, as shown in FIG. 1, each of the condenser lens 40 and the first reflecting mirrors 81 are also located on the one side of the second base wall Fb2 at distances from the second base wall Fb2 in the direction opposite to the first direction.

As shown in FIG. 7, the frame F has a shape such that at least a part of each reflecting mirror 81 is exposed to the outside of the frame F and accessible from a side of the frame F opposite to the first recess CP1 that opens in the first direction. Specifically, the first reflecting mirrors 81 are located in the vicinity of the first base wall Fb1 and exposed to the outside of the first base wall Fb1. In other words, the first base wall Fb1 is not located over the part of each reflecting mirror 81 exposed to the outside of the frame F. Thus, the first reflecting mirrors 81 are exposed to the outside of the frame F without being covered by the first base wall Fb1, and can be attached to the frame F in the first direction.

The first base wall Fb1 has openings H that expose the reflection surfaces of the first reflecting mirrors 81 toward a side of the frame F on which the first recess CP1 is formed (see also FIGS. 5 and 8). The openings H extend in the third direction. Each of the openings H is formed in a shape of a slit elongated in the main scanning direction. Four openings H are provided, one for each of the first reflecting mirrors 81.

The frame F further includes a first partition wall F1 located between the first recess CP1 and the second recess CP2. The first partition wall F1 is connected to the first base wall Fb1 and to the second base wall Fb2 (see also FIG. 8). The first partition wall F1 protrudes from the second base wall Fb2 in the direction opposite to the first direction and protrudes from the first base wall Fb1 in the first direction.

The first partition wall F1 includes two first openings F11, F12 through which light beams BY to BK traveling through the aperture stops 31 of the diaphragm 30 pass toward the polygon mirror 51. The first openings F11, F12 are formed as slits elongate in the first direction. The first openings F11, F12 penetrate the first partition wall F1 in the third direction and have ends opening in the first direction (see FIG. 8). The first opening F11 allows light beams BY, BM to pass therethrough. The first opening F12 allows light beams BC, BK to pass therethrough.

As shown in FIG. 1, the condenser lens 40 is disposed over the first holes F11, F12 shown in FIG. 7. The condenser lens 40 is sandwiched between the first partition wall F1 and the diaphragm 30.

As shown in FIGS. 3 and 8, the frame F further includes two second partition walls F2 disposed on both sides of the polygon mirror 51 at distances from the polygon mirror 51 in the second direction and in the direction opposite to the second direction (see FIG. 3). The second partition wall F2 disposed at a distance from polygon mirror 51 in the second direction has a second opening F21 that allows light beams BY, BM deflected by the polygon mirror 51 to pass therethrough. The other second partition wall F2 disposed at a distance from polygon mirror 51 in the direction opposite to the second direction has a second opening F22 that allows light beams BC, BK deflected by the polygon mirror 51 to pass therethrough. Each of the second openings F21, F22 penetrates a corresponding second partition wall F2 in the second direction and has an end that opens in the first direction.

Each of the second partition walls F2 protrudes from the first base wall Fb1 in the first direction. Each of the second partition walls F2 is connected to the first partition wall F1 and a first side wall F41 which will be described later. In this way, a third recess CP3 for accommodating the polygon mirror 51 is formed by the first base wall Fb1, the first partition wall F1, the second partition walls F2, and the first side wall F41.

The first scan lens 60YM is disposed over part of the second opening F21. The first scan lens 60CK is disposed over part of the second opening F22. Each of the first scan lenses 60YM, 60CK is fixed to a first lens seating surface B1 which is part of the first base wall Fb1. The first lens seating surface B1 is a surface located at a distance in the first direction from a portion of the first base wall Fb1 to which the deflector 50 is attached.

The frame F further includes a first side wall F41, a second side wall F42, a third side wall F43, and a fourth side wall F44 which form an approximately rectangular structure that surrounds the recesses CP1, CP2. The first side wall F41, the second side wall F42, the third side wall F43, and the fourth side wall F44 are an example of a side wall that surrounds the first base wall Fb1. The side wall protrudes from the base wall Fb1 in the first direction along an outer edge of the base wall Fb1 to form an open side of the frame F that opens in the first direction.

The first recess CP1 is surrounded by the first side wall F41, the third side wall F43, the fourth side wall F44, and the first partition wall F1. As shown in FIG. 7, the second recess CP2 is surrounded by the second side wall F42, the third side wall F43, the fourth side wall F44, and the first partition wall F1. In this example, each of the third side wall F43 and the fourth side wall F44 has a portion that corresponds to the first recess CP1 and a portion that corresponds to the second recess CP2. The portion of the third side wall F43 that corresponds to the first recess CP1 is offset from the portion of the third side wall F43 that corresponds to the second recess CP2 in the second direction. The portion of the fourth side wall F44 that corresponds to the first recess CP1 is offset from the portion of the fourth side wall F44 that corresponds to the second recess CP2 in the direction opposite to the second direction.

As shown in FIG. 3, the first side wall F41 is located on a side of the deflector 50 opposite to the other side of the deflector 50 on which the semiconductor lasers 10 are located. The first side wall F41 protrudes from the first base wall Fb1 in the first direction.

The second side wall F42 is located on a side of the deflector 50 opposite to the other side of the deflector 50 on which the first side wall F41 is located. Specifically, the second side wall F42 is located on a side of the coupling lenses 20 opposite to the other side of the coupling lenses 20 on which the deflector 50 is located. The second side wall F42 protrudes from the second base wall Fb2 in the direction opposite to the first direction.

The third side wall F43 is located on a side of the first scan lens 60YM opposite to the other side of the first scan lens 60YM on which the deflector 50 is located. The third side wall F43 is connected to the first side wall F41, the first base wall Fb1, the second base wall Fb2, and the second side wall F42 at respective ends of the walls F41, Fb1, Fb2, F42 facing in the second direction. A portion of the third side wall F43 protrudes from the first base wall Fb1 in the first direction, and another portion of the third side wall F43 protrudes from the second base wall Fb2 in the direction opposite to the first direction.

The fourth side wall F44 is located on a side of the first scan lens 60CK opposite to a side thereof on which the deflector 50 is located. The fourth side wall F44 is connected to the first side wall F41, the first base wall Fb1, the second base wall Fb2, and the second side wall F42 at the respective ends of the walls F41, Fb1, Fb2, F42 facing in the direction opposite to the second direction. A portion of the fourth side wall F44 protrudes from the first base wall Fb1 in the first direction, and another portion of the fourth side wall F44 protrudes from the second base wall Fb2 in the direction opposite to the first direction.

As shown in FIG. 9, the scanning optical device 1 further comprises a support member Fs installable into and removable from the frame F including the first recess CP1, the second recess CP2 and the other portions. The support member Fs is a member for supporting the first reflecting mirror 81. The support member Fs has a seating surface FsZ on which the first reflecting mirror 81 is supported. The seating surface FsZ allows adjustment of an angle of the first reflecting mirror 81. The seating surface FsZ includes a spherical protrusion Fs1 capable of supporting the first reflecting mirror 81 in a manner that allows the first reflecting mirror 81 to be tilted. The protrusion Fs1 protrudes toward the first reflecting mirror 81, and is in contact with the first reflecting mirror 81. The protrusion Fs1 serves as a supporting point on which the first reflecting mirror 81 is tiltably supported during adjustment of an orientation or an angle of the first reflecting mirror 81. The orientation of the first reflecting mirror 81 with respect to the seating surface FsZ is fixed by a photo-curable resin P. The photo-curable resin P may be, for example, a ultraviolet-curable resin. The first reflecting mirror 81 and the support member Fs fixed to each other by the photo-curable resin P are attached to the frame F by a U-shaped leaf spring SP.

The leaf spring SP is an example of a spring which presses the first reflecting mirror 81 against the seating surface FsZ. The leaf spring SP has an opening SPK which allows light for curing the photo-curable resin P to pass through (see FIG. 1). The frame F has a shape such that a part of the reflecting mirror 81 that overlaps the seating surface FsZ in a direction of thickness of the reflecting mirror 81 (a direction perpendicular to the reflection surface) is exposed to an outside of the frame F and accessible from a side of the frame F opposite to the open side of the frame F. The first reflecting mirror 81 does not have a reflection film which forms the reflection surface, on both ends in the third direction. Thus, light having passed through the opening SPK reaches the photo-curable resin P.

The support member Fs and the leaf spring SP are provided at both ends of each first reflecting mirror 81. The pair of support members Fs and the pair of leaf springs SP are provided for each of the four first reflecting mirrors 81.

The frame F has a supporting surface Fm1 for supporting the support member Fs. The supporting surface Fm1 is located in positions corresponding to the ends of each of the four first reflecting mirrors 81 (see FIG. 7).

When each of the first reflecting mirrors 81 is attached to the frame F, the photo-curable resin P is applied to both sides of the protrusion Fs1 of the corresponding support member Fs, and then the support member Fs is attached to the supporting surface Fm1. Subsequently, the first reflecting mirror 81 is positioned in contact with the protrusion Fs1 of the corresponding support member Fs. At this point in time, the photo-curable resin P is in contact with both of the support member Fs and the first reflecting mirror 81. Next, the leaf spring SP is attached to the frame F, whereby the first reflecting mirror 81 is pressed together with the support member Fs against the frame F. The angle of the first reflecting mirror 81 is adjusted by tilting the first reflecting mirror 81 supported on the protrusion Fs1 while observing the position of the light beam on the image plane as light is being emitted from the semiconductor laser 10. Adjustment of the angle of the first reflecting mirror 81 is performed by pressing an arm AM, shown by a chain double-dashed line in FIG. 9, on the first reflecting mirror 81 to move the first reflecting mirror 81. After adjustment of the angle is finished, the first reflecting mirror 81 is fixed to the support member Fs by applying light such as ultraviolet light on the photo-curable resin P.

As shown in FIGS. 3 and 8, the frame F further includes first walls W1, second walls W2, and third walls W3.

Each of the first walls W1 supports a corresponding second scan lens 70Y, 70M, 70C, 70K. Each of the first walls W1 protrude from the first base wall Fb1 in the first direction. One first wall W1 is disposed at both ends (facing in the third direction and in a direction opposite to the third direction) of the second scan lenses 70Y, 70M, 70C, 70K. Each of the first walls W1 has a second lens seating surface W11 having a shape of a slot recessed in the direction opposite to the first direction. The ends of the second scan lenses 70Y, 70M, 70C, 70K are received in respective second lens seating surfaces W11. The ends of the second scan lenses 70Y, 70M, 70C, 70K are pressed against the respective second lens seating surfaces W11 facing in the first direction, and fixed to the frame F by springs (not shown).

The second walls W2 are disposed in positions apart from both ends of the second scan lenses 70Y, 70M, 70C, 70K and extend in a direction parallel to the first walls W1. In this example, the first partition wall F1 and the first side wall F41 form the second walls W2.

The third walls W3 extend in a direction perpendicular to the first direction. The third walls W3 connect the first walls W1 and the second walls W2.

According to the above-described example, the following advantageous effects can be obtained.

According to the scanning optical systems LoY, LoM, LoC, LoK of the scanning optical device 1 of the above-described example, by locating each of the second scan lenses 70Y, 70M, 70C, 70K at a position closest to a corresponding image plane, the distance from the last scan lens to a corresponding photosensitive drum 200 can be reduced. In this way, the sensitivity of the scanning optical device 1 to tolerances can be reduced.

Since the second scan lenses 70Y, 70M, 70C, 70K of the scanning optical systems LoY, LoM, LoC, LoK are aligned in a straight line parallel to the second direction, the distances from the second scan lenses 70Y, 70M, 70C, 70K to the corresponding image planes can be made equal.

Since the first scan lens 60YM of the first scanning optical system LoY and the first scan lens 60YM of the second scanning optical system LoM are comprised of a single common lens, and the first scan lens 60CK of the third scanning optical system LoC and the first scan lens 60CK of the fourth scanning optical system LoK are comprised of a single common lens 60CK, the number of components can be reduced. Thus, the scanning optical device 1 can be downsized.

Since the first scan lens 60YM and the second scan lens 70M of the second scanning optical system LoM are arranged to overlap each other as viewed in the first direction, the second scan lens 70M can be disposed near the polygon mirror 51. Thus, the scanning optical device 1 can be downsized.

Since the first scan lens 60YM is located between the polygon mirror 51 and the path of the light beam BM traveling from the first reflecting mirror 81M of the second scanning optical system LoM toward the second scan lens 70M, the distance between the polygon mirror 51 and the first scan lens 60YM can be made shorter.

Similarly, since the first scan lens 60CK is located between the polygon mirror 51 and the path of the light beam BC traveling from the first reflecting mirror 81C of the third scanning optical system LoC toward the second scan lens 70C, the distance between the polygon mirror 51 and the first scan lens 60CK can be made shorter.

Since the first scanning optical system LoY and the fourth scanning optical system LoK each comprise a single reflecting mirror, and the second scanning optical system LoM and the third scanning optical system LoC each comprise two reflecting mirrors, the number of reflecting mirrors can be reduced.

Since the frame F comprises first walls W1 that support the second scan lenses 70Y, 70M, 70C, 70K, the second scan lenses 70Y, 70M, 70C, 70K can be more accurately positioned relative to the polygon mirror 51.

Since the frame F includes third walls W3 that connect the first walls W1 and the second walls W2, the strength of the first walls W1 supporting the second scan lenses 70Y, 70M, 70C, 70K can be increased.

In the first scanning optical system LoY and the second scanning optical system LoM, the centers C1, C2 of the respective second scan lenses 70Y, 70M in the sub scanning direction are each offset in the sub scanning direction with respect to paths of corresponding light beams BY, BM passing through the second scan lenses 70Y, 70M. Further, in the third scanning optical system LoC and the fourth scanning optical system LoK, the centers C3, C4 of the respective second scan lenses 70C, 70K in the sub scanning direction are each offset in the direction opposite to the second direction with respect to paths of corresponding light beams BC, BK passing through the second scan lenses 70C, 70K. Thus, the distance between the second scan lens 70M of the second scanning optical system LoM and the second scan lens 70C of the third scanning optical system LoC can be made greater. As a result, the distance between the second scan lens 70M of the second scanning optical system LoM and the second scan lens 70C of the third scanning optical system LoC can be made greater without making the distances between each of the light beams BY, BM, BC, BK greater; thus, the upsizing of the scanning optical device 1 can be restrained.

An angle which each of the straight lines L1, L2 parallel to the sub scanning direction of a corresponding second scan lens 70Y, 70M of the first scanning optical system LoY or the second scanning optical system LoM form with a line parallel to the second direction is different from an angle which each of the straight lines L3, L4 parallel to the sub scanning direction of a corresponding second scan lens 70C, 70K of the third scanning optical system LoC or the fourth scanning optical system LoK form with a line parallel to the second direction. Thus, the light beams BY, BM, BC, BK let out from the respective second scan lenses 70Y, 70M, 70C, 70K can be angled with respect to the first direction.

The frame F includes a seating surface FsZ that supports the first reflecting mirror 81and allows adjustment of an angle of the first reflecting mirror 81. The frame F has a shape such that at least part of the reflecting mirror 81 is exposed to an outside of the frame and accessible from a side of the frame F opposite to the open side thereof which opens in the first direction. Therefore, the angle of the first reflecting mirror 81 can be adjusted from a side of the frame F opposite to a side from which light beams are let out. Thus, it is easier to adjust an angle of the first reflecting mirror 81 during assembly of the scanning optical device 1.

Since the seating surface FsZ of the support member Fs includes the protrusion Fs1 that acts as a supporting point during adjustment of the orientation of the first reflecting mirror 81, it is easier to adjust the orientation of the first reflecting mirror 81.

Since the frame F is comprised of a main frame Fm and a support member Fs, the first reflecting mirror 81 can be removed without adversely affecting the main frame Fm if adjustment of the angle of the reflecting mirror 81 has ended in failure when assembling the scanning optical device. As a result, attachment of the first reflecting mirror 81 can be performed over again even if the adjustment of the angle has ended in failure.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

Although a part of the scanning optical system Lo is attached to one side of the first base wall Fb1 in the above-described example, the whole scanning optical system Lo may be attached to the one side of the first base wall Fb1.

Although a leaf spring SP is given as an example of a spring in the above-described example, the spring is not limited to a leaf spring and may be a wire spring or the like.

Although the frame F and the support member Fs including the seating surface FsZ are different members in the above-described example, the seating surface FsZ may be formed integrally with the frame F.

Although the second scan lenses 70 are fixed to the frame by springs (not shown) in the above-described example, the method for fixing the second scan lenses 70 may include adhesion by a photo-curable resin or the like.

Although each of the semiconductor lasers 10 is configured to include one light emission point in the above-described example, the semiconductor lasers 10 may be configured to include a plurality of light emission points. In this case, a plurality of streams of light from each of the semiconductor lasers 10 are converted to a plurality of light beams by a single coupling lens 20, and the plurality of light beams form images on the surface of the photosensitive drum 200 by a corresponding scanning optical system Lo. In such configuration, each of the light beams BY, BM, BC, BK include a plurality of light beams.

The elements described in the above example embodiments and its modified examples may be implemented selectively and in combination.

What is claimed is:

1. A scanning optical device comprising:
a light source configured to emit a light beam;
a polygon mirror configured to deflect the light beam emitted from the light source;
a motor configured to rotate the polygon mirror about a rotation axis parallel to a first direction;
a scanning optical system comprising:
a first scan lens through which to receive the light beam deflected by the polygon mirror;
a second scan lens through which to direct the light beam toward an image plane; and
a reflecting mirror arranged to reflect the light beam toward the second scan lens;
a frame to which the scanning optical system is fixed, the frame comprising:
a base wall to which the motor is fixed; and
a side wall protruding from the base wall in the first direction along an outer edge of the base wall to form an open side of the frame that opens in the first direction; and
a seating surface on which the reflecting mirror is supported, the seating surface being configured to allow adjustment of an angle of the reflecting mirror,
wherein the reflecting mirror reflects the light beam toward the open side, and
wherein a part of the reflecting mirror that overlaps the seating surface as viewed in a direction of thickness of the reflecting mirror is exposed to an outside of the frame and accessible from a side of the frame opposite to the open side of the frame.

2. The scanning optical device according to claim 1, wherein the base wall has a first opening elongated in a main scanning direction of the light beam and configured to allow a reflection surface of the reflecting mirror to be exposed toward the open side of the frame.

3. The scanning optical device according to claim 1, wherein the reflecting mirror overlaps the second scan lens as viewed in the first direction.

4. The scanning optical device according to claim 1, wherein the angle of the reflecting mirror with respect to the seating surface is fixed by a photo-curable resin.

5. The scanning optical device according to claim 4, wherein the seating surface includes a protrusion that protrudes toward the reflecting mirror and is in contact with the reflecting mirror to serve as a supporting point when the angle of the reflecting mirror is adjusted.

6. The scanning optical device according to claim 4, further comprising a spring configured to press the reflecting mirror against the seating surface,
wherein the spring has a second opening that allows light for curing the photo-curable resin to pass therethrough.

7. The scanning optical device according to claim 1, further comprising a supporting member having the seating surface, the supporting member being attached to the frame.

8. A scanning optical device comprising:
a light source configured to emit a light beam;
a polygon mirror configured to deflect the light beam emitted from the light source;
a motor configured to rotate the polygon mirror about a rotation axis parallel to a first direction;
a first scanning optical system located on one side of the polygon mirror at a distance from the polygon mirror in a second direction perpendicular to the first direction, the first scanning optical system being configured to receive the light beam deflected by the polygon mirror and direct the light beam from a first position toward a first image plane;
a second scanning optical system located on the one side of the polygon mirror at a distance from the polygon mirror in the second direction, the second scanning optical system being configured to receive the light beam deflected by the polygon mirror and direct the light beam toward a second image plane, from a second position located closer, than the first position, to the polygon mirror;
a third scanning optical system located on another side of the polygon mirror at a distance from the polygon mirror in a direction opposite to the second direction, the third scanning optical system being configured to receive the light beam deflected by the polygon mirror and direct the light beam from a third position toward a third image plane;
a fourth scanning optical system located on the another side of the polygon mirror at a distance from the polygon mirror in the direction opposite to the second direction, the fourth scanning optical system being configured to receive the light beam deflected by the polygon mirror and direct the light beam toward a fourth image plane, from a fourth position located farther, than the third position, from the polygon mirror; and
a frame to which the first scanning optical system, the second scanning optical system, the third scanning optical system, and the fourth scanning optical system are fixed, the frame comprising:
a base wall to which the motor is fixed; and
a side wall protruding from the base wall in the first direction along an outer edge of the base wall to form an open side of the frame that opens in the first direction,
wherein each of the first scanning optical system, the second scanning optical system, the third scanning optical system, and the fourth scanning optical system comprises:
a first scan lens through which the light beam deflected by the polygon mirror passes;
at least one reflecting mirror arranged to reflect the light beam having passed through the first scan lens; and
a second scan lens through which the light beam reflected by the at least one reflecting mirror passes, and
wherein the second scan lens is arranged apart from the base wall in the first direction to receive a light beam traveling in a direction away from the base wall toward the second scan lens.

9. The scanning optical device according to claim 8, wherein the respective second scan lenses of the first scanning optical system, the second scanning optical system, the third scanning optical system, and the fourth scanning optical system are aligned along a straight line parallel to the second direction.

10. The scanning optical device according to claim 8, wherein
the first scan lens of the first scanning optical system and the first scan lens of the second scanning optical system are comprised of a single common lens, and
the first scan lens of the third scanning optical system and the first scan lens of the fourth scanning optical system are comprised of a single common lens.

11. The scanning optical device according to claim 8, wherein the first scan lens and the second scan lens, in at least one of the scanning optical systems, overlap each other as viewed in the first direction.

12. The scanning optical device according to claim 8, wherein
the at least one reflecting mirror includes a first reflecting mirror arranged to reflect a light beam toward the second scan lens, and
in the second scanning optical system and the third scanning optical system, the first scan lens is located between the polygon mirror and a path of a light beam traveling from the first reflecting mirror toward the second scan lens.

13. The scanning optical device according to claim 8, wherein
each of the first scanning optical system and the fourth scanning optical system includes a single first reflecting mirror as the at least one reflecting mirror, the first reflecting mirror being arranged to reflect a light beam toward the second scan lens, and
each of the second scanning optical system and the third scanning optical system includes a single first reflecting mirror and a single second reflecting mirror, as the at least one reflecting mirror, the first reflecting mirror being arranged to reflect a light beam toward the second scan lens, and the second reflecting mirror being arranged to reflect the light beam deflected by the polygon mirror toward the first reflecting mirror.

14. The scanning optical device according to claim 8, wherein the frame comprises a first wall on which the second scan lens is supported, the first wall protruding from the base wall in the first direction.

15. The scanning optical device according to claim 14, wherein the frame comprises a second wall provided apart from each end of the second scan lens in the longitudinal direction of the second scan lens.

16. The scanning optical device according to claim 15, wherein the frame comprises a third wall extending in a direction perpendicular to the first direction to connect the first wall and the second wall.

17. The scanning optical device according to claim 14, wherein the first wall is configured to support a plurality of the second scan lenses.
